(19) United States
(12) Patent Application Publication
(10) Pub. No.: US 2011/0024709 A1
(43) Pub. Date: Feb. 3, 2011

(54) STAIR RAIL ASSEMBLY

(75) Inventor: Mark B. Lepper, South Bend, IN (US)

Correspondence Address: Mark Lepper;Beautiful Homes, 1301 East 5th Street, Mishawaka, IN, 46544, US

(73) Assignee: Beautiful Homes, Inc., Mishawaka, IN (US)

(21) Appl. No.: 12/511,355

(22) Filed: Jul. 29, 2009

(51) Int. Cl. E04H 17/14; A44B 21/00; B23P 11/00

(52) U.S. Cl. 256/67; 24/304; 29/428

(57) ABSTRACT

A stair rail assembly and a method of making a stair rail assembly is disclosed. The stair rail assembly comprises a stair rail having a first end and a cross section, a ball having a spherical surface, and a connector having a first surface, a concave surface and a connector cross section which is the same as the cross section of the stair rail. The first end of the stair rail is rigidly attached to the first surface of the connector, the concave surface of the connector is rigidly attached to a segment of the spherical surface of the ball, such that the concave surface is covered by the segment, and the connector is adjustably connected to the ball along any direction.

### FIELD OF THE INVENTION

The present invention relates to improvements in stair rail assemblies, and more particularly, to stair rail assemblies which are easy to assemble and suitable for use with a wide array of stair rails.

### BACKGROUND OF THE INVENTION

Stair rail assemblies with irregular, elaborate and complex geometries are increasing popular, especially in new home construction and in remodeling. Many different kinds of stair rail fittings are available for such stair assemblies. Stair rail fittings connect hand rail to hand rail, hand rail to newel post, handrail to wall, even one fitting can connect into another, etc.

Stair rails with complex or custom shapes are often assembled on site—at the house, condominium or business site where the stair rail will actually be used with its corresponding stair case. A significant problem builders of such stair rail assemblies have is difficultly aligning components of the stair rail assemblies together. If the cuts made to the stair rails are not at the needed correct angles, an end of the stair rail will not match up properly with an adjacent element. Since appearance and aesthetics are important here, a stair rail might need to be scrapped rather than installed at the wrong angle.

The stair rail needs to be aligned properly with the top and the bottom and any intermediate turns in the components which make up the stair rail. For example, a stair rail typically is attached to a series of balusters or posts, and the balusters climb at an angle with respect to a floor or horizontal surface. Also, the stair rail has an end which has to meet up with an end on a newel post or on another stair rail. Although the dimensions may be specified in blueprints, actual tolerance variations must be accounted for.

Traditionally assembly occurs in the following manner. A newel post, which is the upright post about which the steps of an angled, curved or circular staircase wind, is set in position, typcially mounted on a floor or landing. Next, a stair rail is held in correct position but not rigidly attached; measured, and cut to length with a straight angled cut to match with the corresponding part (newel post, another stair rail, rosette). While this approximation technique is fine for relatively simple geometries (such as straight stair rails), the more complex contemprorary designs using up easings and other connecting curved stair rails and goosenecks are quite difficult to cut accurately. Even experienced carpenters will have difficultly with the process. If a cut is made at an angle that is an uncorrectable angle (essentially one where the part cannot be re-cut to or sanded to the appropriate length or angle), then the stair rail and/or the fittings such as goosenecks, level quarter turns, up easings, over easings, etc., cannot be used for that stair case. The stair rail or the fittings is scrap (unless it can be used at a different job site). If the stair rail is cut too long, builders have to spend time shaving and sanding down the stair rail to try to get a good fit. This is tedious and time consuming. Also, additional stair rails may be need to be brought to a job site, which increases need for inventory and resulting costs. This is so in part because manufacturers and builders rely on a complex array of stair case styles and components. The stair rail assembly builder or stair rail assembly manufacturer is forced to carry a large inventory of fittings as well as maintain the ability to create rapidly a custom fitting in a variety of popular woods. If the staircase is not built correctly or is not a “standard” or conventional stair case, then a stair builder or installer may have to wait for a substantial period of time for a custom replacement, since most stair parts manufacturers are unable to maintain a complete inventory of all standard fittings of every conceivable wood species. It would be desirable to provide a low cost device which reduces the need for making difficult cuts on stair rail assemblies, especially those having complex geometries.

### SUMMARY OF THE INVENTION

In accordance with a first aspect, a stair rail assembly and a method of making a stair rail assembly is disclosed. The stair rail assembly comprises a stair rail having a first end and a cross section, a ball having a spherical surface, and a connector having a first surface, a concave surface and a connector cross section which is the same as the cross section of the stair rail. The first end of the stair rail is rigidly attached to the first surface of the connector, the concave surface of the connector is rigidly attached to a segment of the spherical surface of the ball, such that the concave surface is covered by the segment, and the connector is adjustably connected to the ball along any direction.

From the foregoing disclosure and the following more detailed description of various preferred embodiments it will be apparent to those skilled in the art that the present invention provides a significant advance in the technology of stair rail assemblies. Particularly significant in this regard is the potential the invention affords for providing a high quality, low cost stair rail fitting suitable for use with a wide variety of stair rails. Additional features and advantages of various preferred embodiments will be better understood in view of the detailed description provided below.

### BRIEF DESCRIPTION OF THE DRAWINGS

FIG. 1 is an isometric view of a ball, a connector, and a stair rail in accordance with one embodiment.

FIG. 2 is an isometric view of a stair rail assembly formed as a hand rail assembly attached to a wall.

FIG. 3 is an isometric view of a stair rail assembly with a gooseneck.

FIG. 4 is an isometric view of another embodiment of a stair rail assembly, showing a space landing and two rail sections meeting at a right angle.

FIG. 5 is a top side view of the stair rail assembly of FIG. 4.

It should be understood that the appended drawings are not necessarily to scale, presenting a somewhat simplified representation of various features illustrative of the basic principles of the invention. The specific design features of the stair rail assembly as disclosed here will be determined in part by the particular intended application and use environment. Certain features of the illustrated embodiments have been enlarged or distorted relative to others to enhance visualization and clear understanding. In particular, thin features may be thickened, for example, for clarity of illustration. All references to direction and position, unless otherwise indicated, refer to the orientation illustrated in the drawings.

### DETAILED DESCRIPTION OF THE EMBODIMENTS

It will be apparent to those skilled in the art, that is, to those who have knowledge or experience in this area of technology, that many uses and design variations are possible for the stair rail assembly disclosed here. The following detailed discussion of various alternative features and embodiments will illustrate the general principles of the invention with reference to a stair rail fitting or connector particularly suitable for use with stair rail assemblies having complex curves and abrupt changes in height. Other embodiments suitable for other applications will be apparent to those skilled in the art given the benefit of this disclosure.

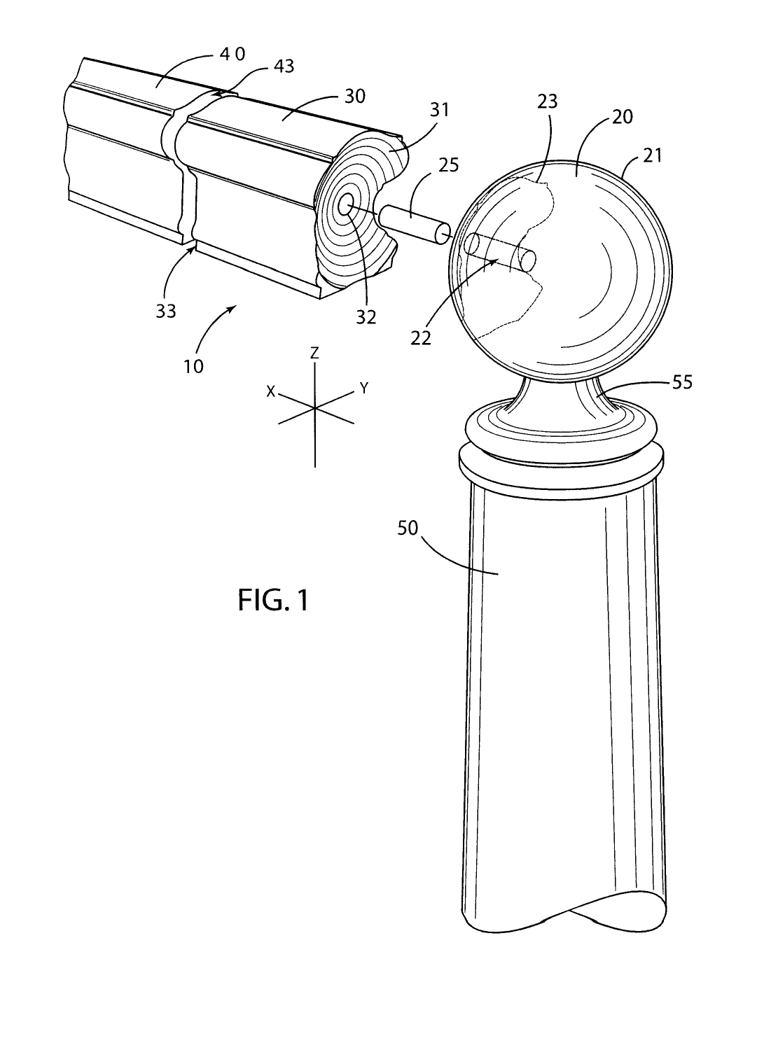

Turning now to the drawings, FIG. 1 shows a stair rail assembly 10 in accordance with one embodiment A stair rail 40 consists of an elongate piece of wood or other material with a cross section cut to a preferred shape as shown. Usually the cross section is uniform across a length of the stair rail. Stair rail 40 has a first end 43 (and a second end not shown in FIG. 1). Each stair rail end is cut flat. That is, the end is straight and not curved, but it can be angled from vertical. That is, the first end may be a flat cut made at right angles to the length of the stair rail, defining the cross section as shown in FIG. 1. Alternatively, the first end may be cut at an acute angle with respect to the length of the stair rail. A ball 20 defines a spherical surface 21. The ball may be a stand alone element or it may be attached to a newel post 50 or formed as a unitary extension (one-piece construction) of the newel post 50. As shown in FIG. 1, the newel post 50 has a neck 55 cut into it, and the ball is formed on the newel post above the neck. The spherical surface 21 of the ball would optionally comprise significant percentage of the exterior of the ball; at least 70% and even more than 90% or a complete 100%, where the ball is a stand alone element not attached to a newel post.

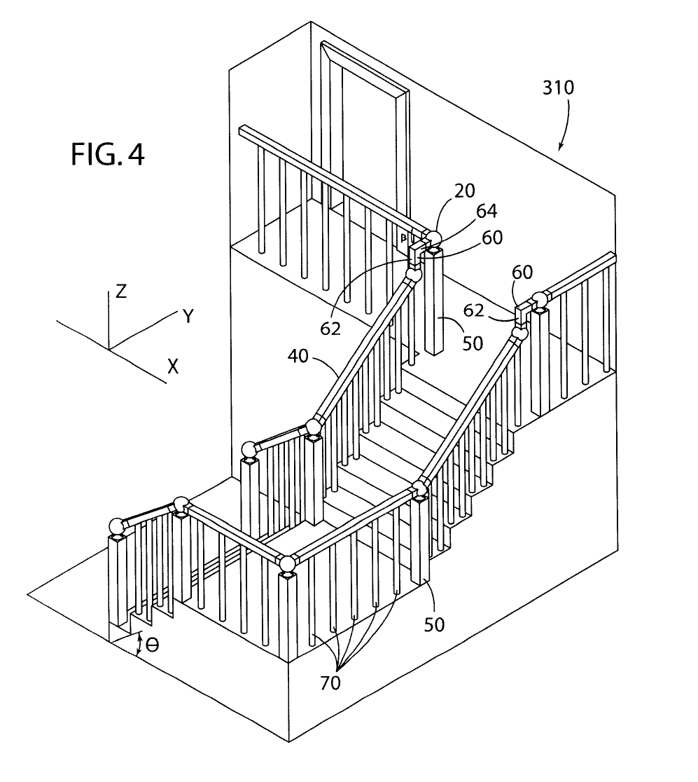

Optionally a series of balusters 70 (shown in FIG. 4) may be positioned underneath the stair rail 40. As used herein, the term newel post refers to posts about which the steps of an angled, curved or circular staircase wind and to which a stair rail assembly is attached. Typically newel posts are positioned at ends of the stair rail, or at landings, or at curves, where interconnections are made, either between elements or where the stair rail begins and ends. Both newel posts and balusters extend from the floor to the stair rail. Typically newel posts can be distinguished over balusters by their size (larger than balusters) and location. Stair rail assemblies normally have at least a pair of newel posts, unless one end is attached directly to a wall or a rosette, and may have more than two.

In accordance with a highly advantageous feature, a connector 30 is positioned between the ball 20 and the stair rail 40. Connector 30 has a first surface 33 and a concave surface 31, as well as a connector cross section which is the same as the cross section of the stair rail 40. The first end 43 of the stair rail is rigidly attached to the first surface 33 of the connector. As shown in Fig.1, the first surface 33 is also flat. The concave surface 31 of the connector 30 is rigidly attached to a segment 23 of the spherical surface 21 of the ball 20, such that the concave surface is covered by the segment and not visible when viewed externally. Thus, the connector 30 serves to make a complex connection between the ball and the stair rail. This is particular advantageous when goosenecks and up easings are used, as otherwise a complex angled cut may need to be made, and such cuts increase the likelihood of error resulting in scrap.

As assembled, the connector 30 is adjustably connected to the ball 20 along any direction. Three axes are provided in FIG. 1 for reference. As used herein, any direction means along the x-axis, y-axis, z-axis, or combinations thereof, and adjustably connected means that one of the two parts may be attached at any one of a variety of different positions with respect to the other of the two parts. For example, adjustment can be made to accommodate the rise in a stair case, so the angle adjustment forming a connection between the connector and the ball is an acute angle in the x-z plane. Other angles of connection will be readily apparent to those skilled in the art given the benefit of this disclosure. Once a position of the connector with respect to its corresponding ball has been determined, the connector may be rigidly attached to that ball. Each connector has a centerline. The ball may advantageously be lined up with the centerline such that the center of the ball is collinear with the centerline of each connector attached to the ball, as shown in the Figs. This is in contrast to known stair rail assemblies where a ball is often positioned above the stair rail, and is used mostly for aesthetic effect.

Optionally the stair rail 40, connector 30 and ball 20 are all made of wood. The connector 30 may be connected to the ball 20 in one of numerous ways. For example, a fastener such as dowel pin 25 may be used, a two sided screw, an adhesive, or a combination of a fastener and adhesive. Where a dowel pin is used, opening or hole 32 in the connector 30 and slot or hole in the ball 20, respectively may be provided to receive the dowel pin 25. The stair rail 40 may be independently connected to the connector in a similar manner by one of a dowel pin, adhesive, and a dowel pin and adhesive. Other suitable elements for connecting the stair rail, connector and ball together will be readily apparent to those skilled in the art given the benefit of this disclosure.

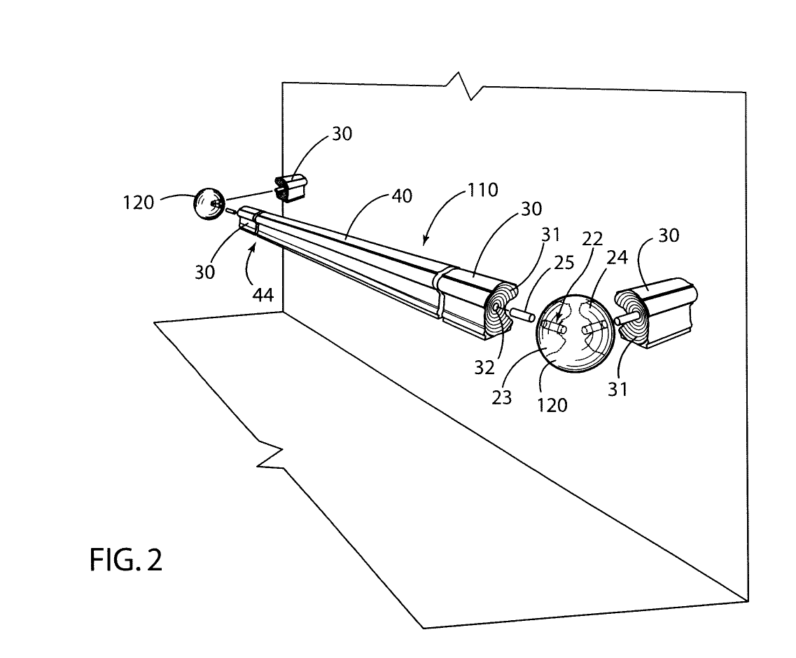

Use of connector 30 allows for many different applications. For example, FIG. 2 shows a stair rail assembly 110 where a second connector 30 is used at a second end 44 of a stair rail 40. Also a second ball 120 is used. Where a second connector is operatively connected to the same ball, the ball may have a second segment 24 which covers a concave surface of the second connector. The balls 120 of FIG. 2 are stand alone and not connected to a newel post. Optionally additional connectors may be used to either connect the stair rail assembly directly to a wall or indirectly through use of a rosette or similar item. Also, another stair rail may be positioned between the connectors and the wall, as desired.

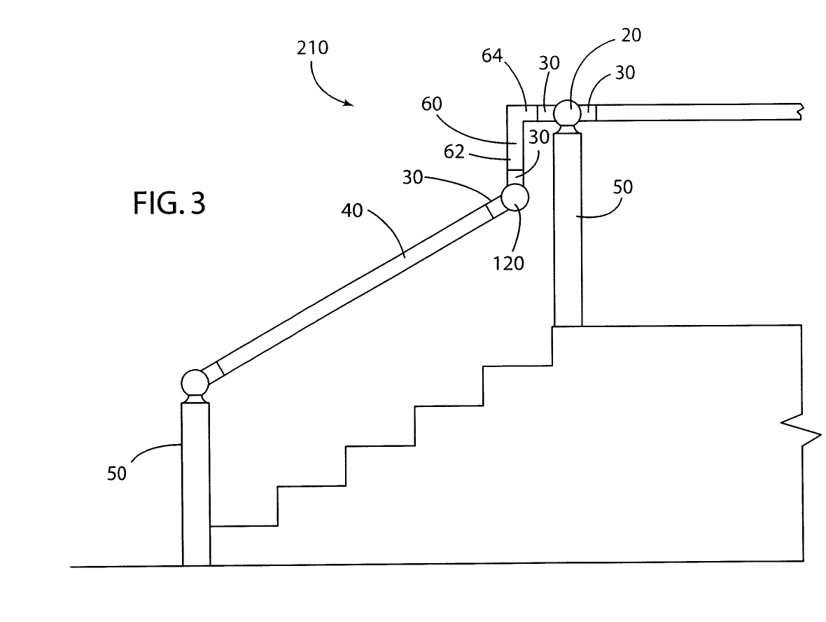

FIG. 3 shows another embodiment 210 where a gooseneck 60 is used. The gooseneck has a gooseneck cross section which is the same as the cross section of the connector cross section, (and the stair rail cross section). The gooseneck comprises a first segment 62 connected to the first surface of the connector 30 (which is in turn connected to ball 120), and a second segment 64 connected to a first surface of a second connector. A second ball can be positioned between the second connector and a third connector. Each connector is advantageously essentially identical. Goosenecks typically have a sharp turn, often a right angle to account for space landings and turns in the stair case, differences in height between steps, or to enhance aesthetics of the stair rail assembly, as desired. Thus, first segment 62 is generally at right angles to second segment 64.

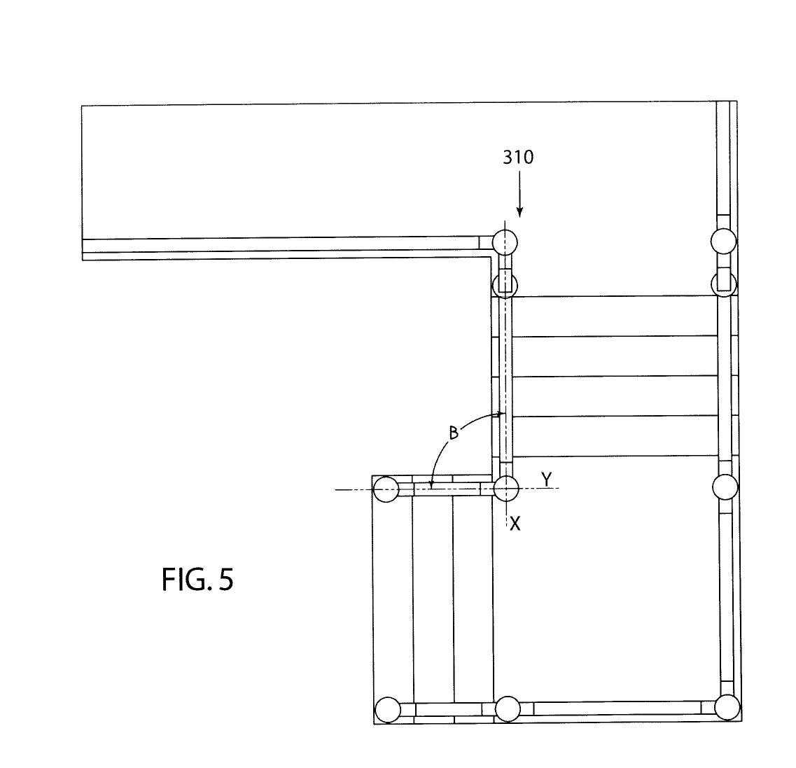

FIGS. 4-5 show another embodiment 310 of a stair rail assembly where a ball is attached to a baluster 70 or newel post 50 adjacent the gooseneck 60. As can be seen in the Fig., a plurality of balusters 70 are connected to the stair rail and adapted to extend to the floor. Here, balls 20 are formed as unitary extensions of newel posts 50 or balusters 70. Optionally the balls may be formed separate, a hole may be drilled into the ball, and the ball can be attached or screwed onto the newel post or baluster. Each connector 30 is adjustably connected to its corresponding ball 20 along all three right angle axes, i.e., connection may be made in any direction or combination of directions over a wide range of adjustment. Thus, some connectors can be connected to their corresponding ball at a wide range of angles along an x-z plane (angle θ), some connectors can be connected a wide range of angles along an x-y plane (angle β), or combinations of angles outside such planes, as required by the design tastes of the person responsible for the design of the stair rail assembly.

One method of assembly of the stair rail assembly is as follows; A first ball is positioned in a first position, such as when the ball is a unitary extension of a newel post, the newel post is attached to the floor. Thus the first position is a fixed position. In a similar manner, a second ball may be positioned in a first position. A first connector and a second connector may also be positioned in a first position. Each connector may be attached to the corresponding ball in the manner discussed above. Alternatively, they may be temporarily held in place against the corresponding ball. Either way, a first distance is defined between a first surface of the first connector and a first surface of the second connector. This distance can be measured. Optionally a stair rail fitting may be held up adjacent the connectors for the measurement. Either way, the stair rail is cut to a length corresponding to the distance between the first surface of the first connector and the first surface of the second connector. Once the stair rail is cut to length, it may be attached to the rest of the elements in the manner described above. Variations of this method may be used to assembly stair assemblies incorporating goosenecks, up easings, and the like. Other methods of assembly will be readily apparent to those skilled in the art given the benefit of this disclosure.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A stair rail assembly comprising, in combination:
a stair rail having a first end and a cross section;
a ball having a spherical surface; and
a connector having a first surface, a concave surface and a connector cross section which is the same as the cross section of the stair rail;
wherein the first end of the stair rail is rigidly attached to the first surface of the connector, the concave surface of the connector is rigidly attached to a segment of the spherical surface of the ball, such that the concave surface is covered by the segment, and the connector is adjustably connected to the ball along any direction.

2. The stair rail assembly of claim 1 wherein the connector is connected to the ball by one of a fastener, adhesive, and a fastener and adhesive, and the stair rail is connected to the connector by one of a fastener, adhesive, and a fastener and adhesive.

3. The stair rail assembly of claim 2 wherein the ball is formed as a unitary extension of a one of a baluster and a newel post adapted to extend to a floor.

4. The stair rail assembly of claim 3 further comprising a plurality of balusters connected to the stair rail and adapted to extend to the floor.

5. The stair rail assembly of claim 1 wherein the spherical surface extends over at least 70% of an exterior of the ball.

6. The stair rail assembly of claim 5 wherein the connector is connected to the ball by a fastener extending into an opening in the connector and a slot in the ball.

7. The stair rail assembly of claim 5 wherein the spherical surface extends over at least 90% of the exterior of the ball.

8. The stair rail assembly of claim 1 further comprising a second connector having a concave surface and a first surface adapted to be connected to a wall, wherein the concave surface of the second connector is adjustably connected to a second segment of the spherical surface of the ball, such that the concave surface is covered by the second segment, and each connector is adjustably connected to the corresponding ball along any direction.

9 The stair rail assembly of claim 1 further comprising a gooseneck having a gooseneck cross section the same as the cross section of the connector cross section, a first segment connected to the first surface of the connector, and a second segment connected to a first surface of a second connector.

10. The stair rail assembly of claim 9 further comprising a second ball positioned between the second connector and a third connector.

11. The stair rail assembly of claim 1 wherein the first end is flat and the first surface is flat.

12. A method of assembling a stair rail assembly comprising, in combination, the steps of:
positioning a first ball, a second ball, a first connector and a second connector all in corresponding first positions, wherein each ball has a spherical surface and each connector has a first surface and a concave surface,
measuring the distance between the first surface of the first connector and the second connector;
cutting a stair rail to a length corresponding to the distance between the first connector and the second connector; and
attaching the first connector to the first ball, attaching the second connector to the second ball, and attached a stair rail to the first connector and to the second connector.

13. The method of claim 12 wherein the stair rail has a first end and a second end, wherein the first end of the stair rail is rigidly attached to the first surface of the first connector, and the concave surface of the first connector is rigidly attached to a segment of the spherical surface of the first ball, such that the concave surface is covered by the segment, and the first connector is adjustably connected to the first ball along any direction.

14. The method of claim 13 wherein the second end of the stair rail is rigidly attached to the first surface of the second connector, and the concave surface of the second connector is rigidly attached to a segment of the spherical surface of the second ball, such that the concave surface is covered by the segment, and the second connector is adjustably connected to the first ball along any direction.
